(19) United States
(12) Patent Application Publication
(10) Pub. No.: US 2021/0194754 A1
(43) Pub. Date: Jun. 24, 2021

(54) SYSTEM AND METHOD FOR RESILIENCY OF DISTRIBUTED DATA FLOW-BASED FRAMEWORK FOR RECONNECTING PEER-TO-PEER COMMUNICATING RUNTIMES

(71) Applicant: Sayantek, Inc, San Jose, CA (US)

(72) Inventor: Murali Kumar Singamsetty, San Jose, CA (US)

(73) Assignee: Sayantek, Inc

(21) Appl. No.: 17/121,801

(22) Filed: Dec. 15, 2020

Related U.S. Application Data
(60) Provisional application No. 62/951,032, filed on Dec. 20, 2019.

(51) Int. Cl. H04L 12/24; H04L 29/08; H04L 12/26

(52) U.S. Cl. CPC H04L 41/0654; H04L 43/10; H04L 67/141

(57) ABSTRACT

A system for resiliency of distributed data flow-based framework is disclosed. A data flow framework deployment identification subsystem identifies one or more nodes, one or more interconnecting wires and one or more runtimes deployed in the distributed dataflow-based framework. A bridge wire implementation subsystem identifies secured transmission control protocol connection established between the one or more runtimes, establishes a publisher on message originating runtime and a subscriber on message receiving runtime, implements one or more bridge wires with each of the one or more runtimes. A data flow framework failure detection subsystem detects loss of connectivity of the at least one network and operational failure of the one or more nodes and the one or more runtimes deployed in the distributed dataflow-based framework. A resiliency attaining subsystem attains predefined level of resiliency of the distributed data flow-based framework over the one or more bridge wires in at least one condition.

### EARLIEST PRIORITY DATE

This application claims priority from a Provisional patent application filed in the United States of America having Patent Application No. 62/951,032, filed on Dec. 20, 2019, and titled “A RESILIENT DISTRIBUTED DATA FLOW METHOD FOR RECONNECTING PEERTO-PEER COMMUNICATING RUNTIMES”.

### BACKGROUND

Embodiment of a present disclosure relates to distributed computing and automation, and more particularly to a system and a resilient distributed data flow method for reconnecting peer-to-peer communicating runtimes.

Several web-based platforms have emerged to ease the development of interactive or near-real-time IoT applications by providing a way to connect things and services together and process the data they emit using a data flow paradigm. Dataflow paradigm is built over information technology (IT) infrastructure and used to architect complex software systems. The distributed dataflow paradigm includes one or more constituents, wherein the one or more constituents do not guarantee fail-proof operation over extended periods. Various methods have been introduced to achieve an acceptable level of resiliency in order to reconnect peer-to-peer communicating runtime back into a DDF system.

One of a conventional distributed data flow framework includes one or more nodes and one or more runtimes connected within a network. However, such a conventional distributed data flow-based framework includes the network which is congested and drops traffic, one or more compute nodes may fail, and battery-powered sensor nodes may purposefully sleep to conserve energy and so on. Regardless of such conditions, real-life systems should provide reasonable assurance of functioning in such conditions and the same applies to a DDF based system. Also, such a conventional system does include one or more self-sufficient nodes which wake up at pre-determined time or event and should be able to participate in a DDF. Moreover, such a conventional DDF system are unable to recover from link failures and temporary loss of connectivity of network and continue to be non-operational which leads to one or more losses.

Hence, there is a need for an improved resilient distributed data flow method for reconnecting peer-to-peer communicating runtimes to address the aforementioned issue(s).

### BRIEF DESCRIPTION

In accordance with an embodiment, of the present disclosure, a system for resiliency of distributed data flow-based framework for reconnecting peer-to-peer communicating runtimes is disclosed. The system includes a data flow framework deployment identification subsystem configured to identify one or more nodes, one or more interconnecting wires and one or more runtimes deployed in the distributed dataflow-based framework. The system also includes a bridge wire implementation subsystem operatively coupled to the data flow framework deployment identification subsystem. The bridge wire implementation subsystem is configured to identify a secured transmission control protocol connection established between the one or more runtimes deployed in the distributed dataflow-based framework for transmission of flow messages. The bridge wire implementation subsystem is also configured to establish a publisher on a message originating runtime and a subscriber on a message receiving runtime based on an identification of the secured transmission control protocol connection established between each of the one or more runtimes. The bridge wire implementation subsystem is also configured to implement one or more bridge wires with each of the one or more runtimes upon identifying a relationship established between the publisher and the subscriber between the one or more runtimes within at least one network. The system also includes a data flow framework failure detection subsystem operatively coupled to the bridge wire implementation subsystem. The data flow framework failure detection subsystem is configured to detect loss of connectivity of the at least one network and operational failure of the one or more nodes and the one or more runtimes deployed in the distributed dataflow-based framework based on implementation of the one or more bridge wires. The system also includes a resiliency attaining subsystem operatively coupled to the data flow framework failure detection subsystem. The resiliency attaining subsystem is configured to attain a predefined level of resiliency of the distributed data flow-based framework over the one or more bridge wires in at least one condition based on the loss of connectivity of the at least one network and operational failure of the one or more nodes detected.

In accordance with another embodiment of the present disclosure, a method for resiliency of distributed data flow-based framework for reconnecting peer-to-peer communicating runtimes is disclosed. The method includes identifying, by a data flow framework deployment identification subsystem, one or more nodes, one or more interconnecting wires and one or more runtimes deployed in the distributed dataflow-based framework. The method also includes identifying, by a bridge wire implementation subsystem, a secured transmission control protocol connection established between the one or more runtimes deployed in the distributed dataflow-based framework for transmission of flow messages. The method also includes establishing, by the bridge wire implementation subsystem, a publisher on a message originating runtime and a subscriber on a message receiving runtime based on an identification of the secured transmission control protocol connection established between each of the one or more runtimes. The method also includes implementing, by the bridge wire implementation subsystem, one or more bridge wires with each of the one or more runtimes upon identifying a relationship established between the publisher and the subscriber between the one or more runtimes within at least one network. The method also includes detecting, by a data flow framework failure detection subsystem, loss of connectivity of the at least one network and operational failure of the one or more nodes and the one or more runtimes deployed in the distributed dataflow-based framework based on implementation of the one or more bridge wires. The method also includes attaining, by a resiliency attaining subsystem, a predefined level of resiliency of the distributed data flow-based framework over the one or more bridge wires in at least one condition based on the loss of connectivity of the at least one network and operational failure of the one or more nodes detected.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for resiliency of distributed data flow-based framework for reconnecting peer-to-peer communicating runtimes in accordance with an embodiment of the present disclosure;

FIG. 2 is a block diagram representation of the controller in the distributed data flow-based framework in accordance with an embodiment of the present disclosure;

FIG. 3 illustrates a schematic representation of an exemplary embodiment of a system for resiliency of distributed data flow-based framework for reconnecting peer-to-peer communicating runtimes of FIG. 1 in accordance with an embodiment of the present disclosure; and

FIG. 4 is a flow chart representing the steps involved in a method for resiliency of distributed data flow-based framework for reconnecting peer-to-peer communicating runtimes in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for resiliency of distributed data flow-based framework for reconnecting peer-to-peer communicating runtimes. The system includes a data flow framework deployment identification subsystem configured to identify one or more nodes, one or more interconnecting wires and one or more runtimes deployed in the distributed dataflow-based framework. The system also includes a bridge wire implementation subsystem operatively coupled to the data flow framework deployment identification subsystem. The bridge wire implementation subsystem is configured to identify a secured transmission control protocol connection established between the one or more runtimes deployed in the distributed dataflow-based framework for transmission of flow messages. The bridge wire implementation subsystem is also configured to establish a publisher on a message originating runtime and a subscriber on a message receiving runtime based on an identification of the secured transmission control protocol connection established between each of the one or more runtimes. The bridge wire implementation subsystem is also configured to implement one or more bridge wires with each of the one or more runtimes upon identifying a relationship established between the publisher and the subscriber between the one or more runtimes within at least one network. The system also includes a data flow framework failure detection subsystem operatively coupled to the bridge wire implementation subsystem. The data flow framework failure detection subsystem is configured to detect loss of connectivity of the at least one network and operational failure of the one or more nodes and the one or more runtimes deployed in the distributed dataflow-based framework based on implementation of the one or more bridge wires. The system also includes a resiliency attaining subsystem operatively coupled to the data flow framework failure detection subsystem. The resiliency attaining subsystem is configured to attain a predefined level of resiliency of the distributed data flow-based framework over the one or more bridge wires in at least one condition based on the loss of connectivity of the at least one network and operational failure of the one or more nodes detected.

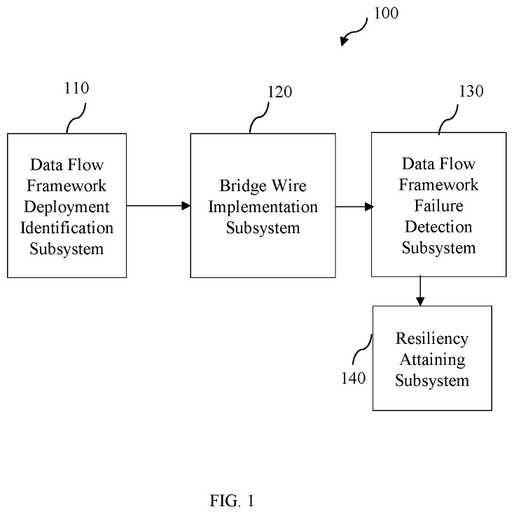

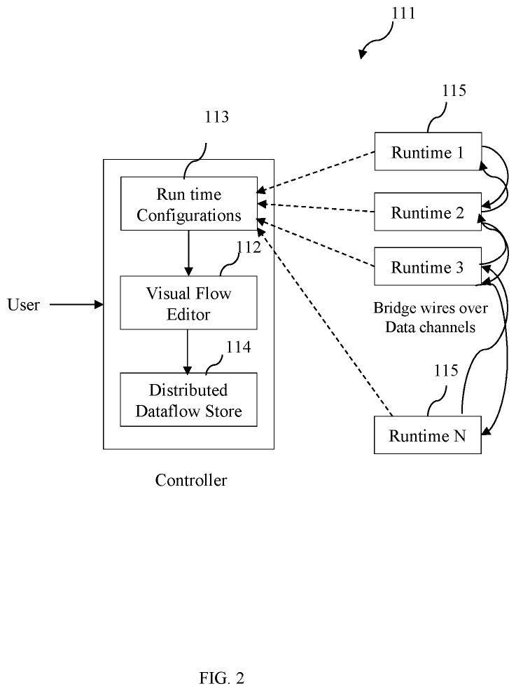

FIG. 1 is a block diagram of a system 100 for resiliency of distributed data flow-based framework for reconnecting peer-to-peer communicating runtimes in accordance with an embodiment of the present disclosure. The system 100 includes a data flow framework deployment identification subsystem 110 configured to identify one or more nodes, one or more interconnecting wires and one or more runtimes deployed in the distributed dataflow-based framework. As used herein, the term ‘runtime’ is defined as a compute node equipped with the necessary functionality to process a flow. Similarly, the term ‘peer-to-peer publisher/subscriber’ is defined as a system of publisher and subscriber entities that communicate directly with the peers on point to point connections. In one embodiment, each of the one or more runtimes in a distributed data flow (DDF) system receives a flow configuration file from a controller prior to establishing the publisher and the subscriber relationship, wherein the flow configuration file may include node configurations, interconnecting wires, runtime configuration including port, IP address and public key information. Similarly, the term ‘distributed data flow (DDF)’ is defined as a dataflow that spans multiple runtimes. Each runtime executes a portion of distributed flow when successfully deployed. One such embodiment of the controller is shown in FIG. 2.

FIG. 2 is a block diagram representation of the controller 111 in the distributed data flow-based framework in accordance with an embodiment of the present disclosure. The DDF framework is designed using a visual flow-based editor 112. The visual flow-based editor 112 is responsible for capturing DDF details as designed by user and deploying the DDF to each of the one or more runtimes. The controller 111 is a centralized management entity. During the installation and provisioning process, each runtime of a DDF system registers with the controller 111 and shares the corresponding runtime configuration information 113. If there is a change in the runtime configuration 113, each of the one or more runtimes promptly updates controller 111 thus enabling controller 111 to maintain a distributed data flow repository or store 114 of latest configurations for each of the one or more runtimes 115. During the deployment phase, each runtime 115 in a DDF system receives complete DDF design from the controller 111, regardless of the portion of the DDF that has been assigned to the runtime in the form of the flow configuration file. In such embodiment, the flow configuration file may include in Javascript Object Notation format (JSON) format.

Referring back to FIG. 1, one or more nodes and one or more wires are deployed based on one or more identified portions of the distributed data flow system upon receiving the flow configuration file. As used herein, the term ‘node’ is defined as a processing block in flow-based programming. The node may have multiple input ports and multiple output ports. In one embodiment, the one or more nodes may include one or more compute nodes or one or more battery powered sensing nodes. The system also includes a bridge wire implementation subsystem operatively coupled to the data flow framework deployment identification subsystem. The bridge wire implementation subsystem 120 is configured to identify a secured transmission control protocol connection established between the one or more runtimes deployed in the distributed dataflow-based framework for transmission of flow messages. In a specific embodiment, the transmission control protocol connection established between the one or more runtimes may include initiation of connection by a publisher of one of a runtime and listening to establish a connection by a subscriber of another runtime among the one or more runtimes.

The bridge wire implementation subsystem 120 is also configured to establish a publisher on a message originating runtime and a subscriber on a message receiving runtime based on an identification of the secured transmission control protocol connection established between each of the one or more runtimes. The bridge wire implementation subsystem 120 is also configured to implement one or more bridge wires with each of the one or more runtimes upon identifying a relationship established between the publisher and the subscriber between the one or more runtimes within at least one network. In one embodiment, the at least one network may include a private network, a public network and a hybrid network.

The system 100 also includes a data flow framework failure detection subsystem 130 operatively coupled to the bridge wire implementation subsystem 120. The data flow framework failure detection subsystem 130 is configured to detect loss of connectivity of the at least one network and operational failure of the one or more nodes and the one or more runtimes deployed in the distributed dataflow-based framework based on implementation of the one or more bridge wires. The system 100 also includes a resiliency attaining subsystem 140 operatively coupled to the data flow framework failure detection subsystem 130. The resiliency attaining subsystem 140 is configured to attain a predefined level of resiliency of the distributed data flow-based framework over the one or more bridge wires in at least one condition based on the loss of connectivity of the at least one network and operational failure of the one or more nodes detected. In one embodiment, the at least one condition may include a reconnection mechanism when a runtime becomes active from an inactive state or down state. In such embodiment, the reconnection mechanism to attain the predefined level of resiliency may include enabling transmission control protocol (TCP) keepalives by transmission control protocol connection utilized by the one or more bridge wires to prevent connections from timing out and getting dropped by one or more network devices. In some embodiment, the reconnection mechanism to attain the predefined level of resiliency may include implementing a heartbeat mechanism over the one or more bridge wires to indicate liveliness of a runtime. The heartbeat mechanism includes each publisher sending periodic “hello messages” to subscribers to indicate liveness of a runtime. When a subscriber does not receive a “hello message” within a predetermined interval, the subscriber assumes that the peer publisher is not active anymore and goes through the reconnection procedure for underlying the TCP connection. The publisher and subscriber services on the runtime need to be rebound to a new connection upon re-establishment of underlying TCP connection. In another embodiment, the reconnection mechanism to attain the predefined level of resiliency may include re-establishment of the transmission control protocol connection through one or more socket operations. In such embodiment, the one or more socket operations may include, but not limited to an INITIATE operation, an ACCEPT operation, a LISTEN operation and the like. If the runtime's socket operation is INITIATE, it periodically attempts to initiate a new connection with flow neighbor until it succeeds. Similarly, if runtime's socket operation is ACCEPT, the runtime's socket performs LISTEN operation on network socket so that when the flow neighbor becomes active again the runtime socket is able to ACCEPT connection initiation from the flow neighbor. In yet another embodiment, the predefined level of resiliency comprises reducing implementation overhead based on automatic reconnection capability of the runtime. To reduce implementation overhead, the one or more runtimes may use automatic reconnection option in sockets if the socket library supports such a capability.

In another embodiment, the at least one condition may include a reconnection mechanism of the one or more bridge wires attached to a runtime when security keys of the one or more runtimes expire. In such embodiment, the reconnection mechanism of the one or more bridge wires when the security keys of the one or more runtimes expire may include utilization of a separate communication channel for one or more administrative tasks, wherein the one or more administrative tasks may include a flow file propagation from a controller to a runtime and a notification of runtime configuration changes from one or more runtimes to the controller of a distributed data flow-based framework.

In a specific embodiment, the reconnection mechanism of the one or more bridge wires when the security keys of the one or more runtimes expire may include requirement of separate security key pairs by the one or more runtimes. In implementations that require data security of the distributed data flow framework, each of the one or more runtimes requires two different security key pairs one for securing control channel communications with the controller and another for securing data channels underlying bridge wires between flow neighbors.

In one embodiment, the reconnection mechanism of the one or more bridge wires when the security keys of the one or more runtimes expire may include refreshing data channel key pair by the one or more runtimes periodically or on demand to improve security posture of the distributed data flow based framework. In this process, a runtime independently creates a new security key pair. The runtime retains the private key of the key pair but shares the public key component with all other runtimes via the controller. The runtime sends a configuration update message to the controller over control channel that includes new public key. The controller updates runtime configurations and updates the DDF and/or its meta data with a new public key and distribute it to the one or more runtimes in the DDF framework for deployment. Any data channel key pair refresh on one or more runtimes triggers a DDF and/or its meta data update, distribution and redeployment of the DDF.

In another embodiment, the reconnection mechanism of the one or more bridge wires when the security keys of the one or more runtimes expire may include deletion or establishment of the one or more bridge wires when a new distributed data flow and/or its metadata update is received by the one or more bridge wires.

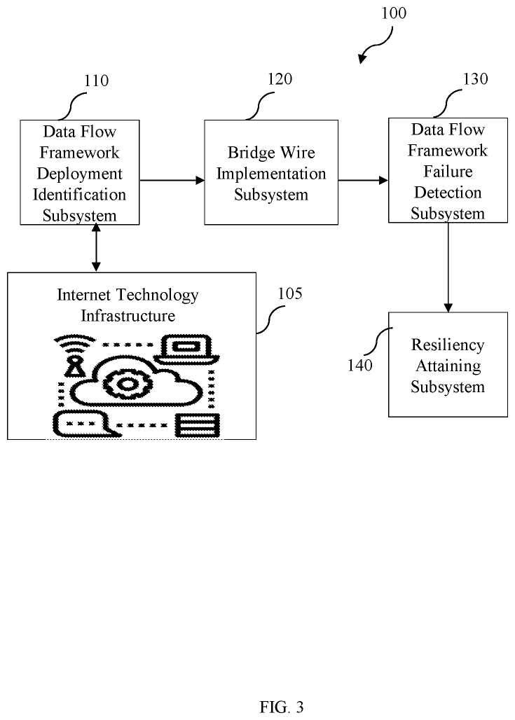

FIG. 3 illustrates a schematic representation of an exemplary embodiment of a system 100 for resiliency of distributed data flow-based framework for reconnecting peer-to-peer communicating runtimes of FIG. 1 in accordance with an embodiment of the present disclosure. A distributed dataflow-based framework uses a dataflow programming model for building IoT applications and services has been designed as a run-time for individual devices. The system 100 is well suited for IoT (internet of things) applications in which data originates from non-human sources such as sensors/machines and eventually consumed for further processing. Considering an example, where a distributed data flow-based framework is built over IT infrastructure 105. In such a scenario, generally, one or more constituents of the IT infrastructure 105 do not guarantee fail-proof operation over extended periods, sometimes there is loss of network connectivity and drop in traffic, compute nodes can fail and battery-powered sensor nodes may purposefully sleep to conserve energy and so on.

In order to overcome such issues, the system 100 provides reasonable assurance of functioning in such conditions and the same applies to a DDF based framework. The system 100 enables the distributed dataflow-based framework to recover from link failures and temporary loss of connectivity and continue to be operational. Failure of one of the participating runtimes should not render the rest of the DDF non-operational. The system 100 includes a data flow framework deployment identification subsystem 110 configured to identify one or more nodes, one or more interconnecting wires and one or more runtimes deployed in the distributed dataflow-based framework. For example, the one or more nodes may include one or more compute nodes or one or more battery powered sensor nodes. In the example used herein, each of the one or more runtimes in a distributed data flow (DDF) system receives a flow configuration file from a controller prior to establishing the publisher and the subscriber relationship, wherein the flow configuration file may include node configurations, interconnecting wires, runtime configuration including port, IP address and public key information.

Once, the deployment of the one or more nodes, the one or more wires and the one or more runtimes are identified, a bridge wire implementation subsystem 120 identifies a secured transmission control protocol connection established between the one or more runtimes deployed in the distributed dataflow-based framework for transmission of flow messages. For example, the transmission control protocol connection established between the one or more runtimes may include initiation of the TCP connection by a publisher of one of a runtime and listening the established connection by a subscriber of another runtime among the one or more runtimes.

Upon establishment of the TCP connection, the bridge wire implementation subsystem 120 establishes a publisher on a message originating runtime and a subscriber on a message receiving runtime. The bridge wire implementation subsystem 120 is also configured to implement one or more bridge wires with each of the one or more runtimes upon identifying a relationship established between the publisher and the subscriber between the one or more runtimes within at least one network. For example, the at least one network may include a private network, a public network and a hybrid network.

Once, the one or more bridge wires are implemented, a data flow framework failure detection subsystem 130 detects loss of connectivity of the at least one network and operational failure of the one or more nodes and the one or more runtimes deployed in the distributed dataflow-based framework. Based on the loss of connectivity of the at least one network and operational failure of the one or more nodes detected, a resiliency attaining subsystem 140 attains a predefined level of resiliency of the distributed data flow-based framework over the one or more bridge wires in at least one condition. For example, the at least one condition may include a reconnection mechanism when a runtime becomes active from an inactive state or down state. Similarly, another condition may include a reconnection mechanism of the one or more bridge wires attached to a runtime when security keys of the one or more runtimes expire. Suppose, if the one or more nodes in the IT infrastructure are at down or inactive state, then the reconnection mechanism to attain the predefined level of resiliency may include enabling transmission control protocol (TCP) keepalives by transmission control protocol connection utilized by the one or more bridge wires to prevent connections from timing out and getting deleted by one or more network devices. Again, the reconnection mechanism to attain the predefined level of resiliency may include implementing a heartbeat mechanism over the one or more bridge wires to indicate liveliness of a runtime. The heartbeat mechanism includes each publisher sending periodic “hello messages” to subscribers to indicate liveness of a runtime. When a subscriber does not receive a “hello message” within a predetermined interval, the subscriber assumes that the peer publisher is not active anymore and goes through the reconnection procedure for underlying the TCP connection. The publisher and subscriber services on the runtime need to be rebound to a new connection upon re-establishment of underlying TCP connection.

Also, the reconnection mechanism to prevent fail proof operation may include re-establishment of the transmission control protocol connection through one or more socket operations. For example, the one or more socket operations may include, but not limited to an INITIATE operation, an ACCEPT operation, a LISTEN operation and the like. If the runtime's socket operation is INITIATE, it periodically attempts to initiate a new connection with flow neighbor until it succeeds. Similarly, if runtime's socket operation is ACCEPT, the runtime's socket performs LISTEN operation on network socket so that when the flow neighbor becomes active again the runtime socket is able to ACCEPT connection initiation from the flow neighbor.

Again, the reconnection of bridge wires attached to a runtime when security keys of the runtime expire, and they are refreshed independently by the runtime includes reconnection of the one or more bridge wires by utilization of a separate communication channel for one or more administrative tasks. For example, the one or more administrative tasks may include a flow file propagation from a controller to a runtime and a notification of runtime configuration changes from one or more runtimes to the controller of a distributed data flow-based framework. In another scenario, the reconnection mechanism of the one or more bridge wires when the security keys of the one or more runtimes expire may include requirement of separate security key pairs by the one or more runtimes. In implementations that require data security of the distributed data flow framework, each of the one or more runtimes requires two different security key pairs one for securing control channel communications with the controller and another for securing data channels underlying bridge wires between flow neighbors.

In addition, the reconnection mechanism of the one or more bridge wires when the security keys of the one or more runtimes expire may include refreshing data channel key pair by the one or more runtimes periodically or on demand to improve security posture of the distributed data flow based framework. In this process, a runtime independently creates a new security key pair. The runtime retains the private key of the key pair but shares the public key component with all other runtimes via the controller. The runtime sends a configuration update message to the controller over control channel that includes new public key. The controller updates runtime configurations and updates the DDF and/or its meta data with a new public key and distribute it to the one or more runtimes in the DDF framework for deployment. Any data channel key pair refresh on one or more runtimes triggers a DDF and/or its meta data update, distribution and re-deployment of the DDF. Also, the reconnection mechanism of the one or more bridge wires when the security keys of the one or more runtimes expire may include deletion or establishment of the one or more bridge wires when a new distributed data flow framework and/or its meta data update is received by the one or more bridge wires.

Thus, the resiliency achieved through several connection mechanisms ensures reliable message delivery over bridge wires and enables reconnecting peer-to-peer communicating nodes by elimination of centralized message broker to improve system resilience and also eliminating a single point of failure in the data plane. This enables a significant portion of distributed data flow processing at the edge of the network where IoT data originates without incurring additional costs involved in sending data to the message broker.

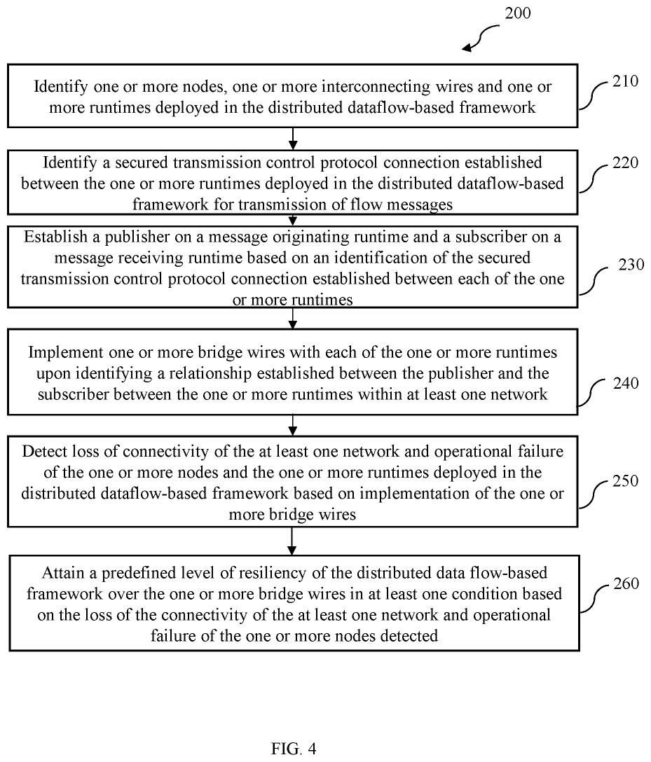

FIG. 4 is a flow chart representing the steps involved in a method 200 for resiliency of distributed data flow-based framework for reconnecting peer-to-peer communicating runtimes in accordance with the embodiment of the present disclosure. The method 200 includes identifying, by a data flow framework deployment identification subsystem, one or more nodes, one or more interconnecting wires and one or more runtimes deployed in the distributed dataflow-based framework in step 210. In one embodiment, identifying the one or more nodes, the one or more interconnecting wires and one or more runtimes deployed in the distributed dataflow-based framework may include identifying one or more compute nodes or one or more battery powered sensing nodes. In some embodiment, identifying the one or more runtimes may include identifying the one or more runtimes in a distributed data flow (DDF) system which receives a flow configuration file from a controller prior to establishing the publisher and the subscriber relationship. In such embodiment, the flow configuration file may include, but not limited to, node configurations, interconnecting wires, runtime configuration including port, IP address and public key information.

The method 200 also includes identifying, by a bridge wire implementation subsystem, a secured transmission control protocol connection established between the one or more runtimes deployed in the distributed dataflow-based framework for transmission of flow messages in step 220. In one embodiment, identifying the secured transmission control protocol (TCP) connection established between the one or more runtimes may include identifying the transmission control protocol connection established between the one or more runtimes via initiation of connection by a publisher of one of a runtime and listening the established connection by a subscriber of another runtime among the one or more runtimes.

The method 200 also includes establishing, by the bridge wire implementation subsystem, a publisher on a message originating runtime and a subscriber on a message receiving runtime based on an identification of the secured transmission control protocol connection established between each of the one or more runtimes in step 230. The method 200 also includes implementing, by the bridge wire implementation subsystem, one or more bridge wires with each of the one or more runtimes upon identifying a relationship established between the publisher and the subscriber between the one or more runtimes within at least one network in step 240. Each of the one or more runtimes needs to work independently and set up one or more necessary bridge wires autonomously. The autonomous set up of the one or more bridge wires includes having complete details of flow neighbor's reachability.

The method 200 also includes detecting, by a data flow framework failure detection subsystem, loss of connectivity of the at least one network and operational failure of the one or more nodes and the one or more runtimes deployed in the distributed dataflow-based framework based on implementation of the one or more bridge wires in step 250. In one embodiment, detecting the loss of connectivity of the at least one network may include detecting loss of connectivity of at least one of a private network, a public network, a hybrid network and the like.

The method 200 also includes attaining, by a resiliency attaining subsystem, a predefined level of resiliency of the distributed data flow-based framework over the one or more bridge wires in at least one condition based on the loss of connectivity of the at least one network and operational failure of the one or more nodes detected in step 260. In one embodiment, attaining the predefined level of resiliency of the distributed data flow-based framework over the one or more bridge wires in the at least one condition may include attaining the predefined level of resiliency of the distributed data flow-based framework over the one or more bridge wires in the at least one condition which includes a reconnection mechanism when a runtime becomes active from an inactive state or down state. In such embodiment, the reconnection mechanism to attain the predefined level of resiliency may include enabling transmission control protocol (TCP) keepalives by transmission control protocol connection utilized by the one or more bridge wires to prevent connections from timing out and getting deleted by one or more network devices. In another embodiment, attaining the predefined level of resiliency of the distributed data flow-based framework over the one or more bridge wires in the at least one condition may include the reconnection mechanism by implementing a heartbeat mechanism over the one or more bridge wires to indicate liveliness of a runtime. In yet another embodiment, the reconnection mechanism to attain the predefined level of resiliency may include re-establishment of the transmission control protocol connection through one or more socket operations. In one embodiment, the reconnection mechanism to attain the predefined level of the resiliency may include reducing implementation overhead based on automatic reconnection capability of the runtime. In another embodiment, the at least one condition may include a reconnection mechanism of the one or more bridge wires attached to a runtime when security keys of the one or more runtimes expire. In such embodiment, the reconnection mechanism of the one or more bridge wires when the security keys of the one or more runtimes expire may include utilization of a separate communication channel for one or more administrative tasks, wherein the one or more administrative tasks may include a flow file propagation from a controller to a runtime and a notification of runtime configuration changes from one or more runtimes to the controller of a distributed data flow-based framework.

Various embodiments of the present disclosure for reconnecting peer-to-peer communicating nodes described above enables elimination of centralized message broker to improve system resilience by also eliminating a single point of failure in the data plane. This enables a significant portion of distributed data flow processing at the edge of the network where IoT data originates without incurring additional costs involved in sending data to the message broker.

Moreover, direct transport of flow messages between runtime neighbors or peer to peer messaging reduces the latency and supports real-time processing requirements of time-critical applications.

Furthermore, the present disclosed system implements a confirmed send and acknowledged receive nodes that can be used pairwise over any bridge wire to achieve guarantee of message delivery when such reliable delivery is required for a particular application.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for resiliency of distributed data flow-based framework for reconnecting peer-to-peer communicating runtimes comprising:
a data flow framework deployment identification subsystem configured to identify one or more nodes, one or more interconnecting wires and one or more runtimes deployed in the distributed dataflow-based framework;
a bridge wire implementation subsystem operatively coupled to the data flow framework deployment identification subsystem, wherein the bridge wire implementation subsystem is configured to:
identify a secured transmission control protocol connection established between the one or more runtimes deployed in the distributed dataflow-based framework for transmission of flow messages;
establish a publisher on a message originating runtime and a subscriber on a message receiving runtime based on an identification of the secured transmission control protocol connection established between each of the one or more runtimes; and
implement one or more bridge wires with each of the one or more runtimes upon identifying a relationship established between the publisher and the subscriber between the one or more runtimes within at least one network;
a data flow framework failure detection subsystem operatively coupled to the bridge wire implementation subsystem, wherein the data flow framework failure detection subsystem is configured to detect loss of connectivity of the at least one network and operational failure of the one or more nodes and the one or more runtimes deployed in the distributed dataflow-based framework based on implementation of the one or more bridge wires; and
a resiliency attaining subsystem operatively coupled to the data flow framework failure detection subsystem, wherein the resiliency attaining subsystem is configured to attain a predefined level of resiliency of the distributed data flow-based framework over the one or more bridge wires in at least one condition based on the loss of connectivity of the at least one network and operational failure of the one or more nodes detected.

2. The system of claim 1, wherein the one or more nodes comprises one or more compute nodes or one or more battery powered sensing nodes.

3. The system of claim 1, wherein the one or more runtimes comprises one or more compute nodes equipped with a predetermined functionality for execution of distributed data flow.

4. The system of claim 1, wherein the one or more runtimes in the distributed data flow framework receives a flow configuration file from a controller prior to establishing a relationship between the publisher and the subscriber.

5. The system of claim 4, wherein the flow configuration file comprises one or more node configurations, configurations of the one or more interconnecting wires, runtime configuration including port, internet protocol address and public key information.

6. The system of claim 1, wherein the transmission control protocol connection established between the one or more runtimes comprises initiation of connection by a publisher of one of a runtime and listening the established connection by a subscriber of another runtime among the one or more runtimes.

7. The system of claim 1, wherein the at least one network comprises a private network, a public network and a hybrid network.

8. The system of claim 1, wherein the at least one condition comprises reconnection mechanism when a runtime becomes active from an inactive state or down state.

9. The system of claim 8, wherein the reconnection mechanism to attain the predefined level of resiliency comprises enabling transmission control protocol keepalives by transmission control protocol connection utilized by the one or more bridge wires to prevent connections from timing out and getting deleted by one or more network devices.

10. The system of claim 8, wherein the reconnection mechanism to attain the predefined level of resiliency comprises implementing a heartbeat mechanism over the one or more bridge wires to indicate liveliness of a runtime.

11. The system of claim 8, wherein the reconnection mechanism to attain the predefined level of resiliency comprises re-establishment of the transmission control protocol connection through one or more socket operations.

12. The system of claim 8, wherein the reconnection mechanism to attain the predefined level of resiliency comprises reducing implementation overhead based on automatic reconnection capability of the runtime.

13. The system of claim 1, wherein the at least one condition comprises a reconnection mechanism of the one or more bridge wires attached to a runtime when security keys of the one or more runtimes expire.

14. The system of claim 13, wherein the reconnection mechanism of the one or more bridge wires when the security keys of the one or more runtimes expire comprises utilization of a separate communication channel for one or more administrative tasks, wherein the one or more administrative tasks comprises a flow file propagation from a controller to a runtime and a notification of runtime configuration changes from one or more runtimes to the controller of a distributed data flow-based framework.

15. The system of claim 13, wherein the reconnection mechanism of the one or more bridge wires when the security keys of the one or more runtimes expire comprises requirement of separate security key pairs by the one or more runtimes.

16. The system of claim 13, wherein the reconnection mechanism of the one or more bridge wires when the security keys of the one or more runtimes expire comprises refreshing data channel key pair by the one or more runtimes periodically or on demand to improve security posture of the distributed data flow based framework.

17. The system of claim 13, wherein the reconnection mechanism of the one or more bridge wires when the security keys of the one or more runtimes expire comprises deletion or establishment of the one or more bridge wires when a new distributed data flow framework and/or metadata update is received by the one or more bridge wires.

18. A method comprising:
identifying, by a data flow framework deployment identification subsystem, one or more nodes, one or more interconnecting wires and one or more runtimes deployed in the distributed dataflow-based framework;
identifying, by a bridge wire implementation subsystem, a secured transmission control protocol connection established between the one or more runtimes deployed in the distributed dataflow-based framework for transmission of flow messages;
establishing, by the bridge wire implementation subsystem, a publisher on a message originating runtime and a subscriber on a message receiving runtime based on an identification of the secured transmission control protocol connection established between each of the one or more runtimes;
implementing, by the bridge wire implementation subsystem, one or more bridge wires with each of the one or more runtimes upon identifying a relationship established between the publisher and the subscriber between the one or more runtimes within at least one network;
detecting, by a data flow framework failure detection subsystem, loss of connectivity of the at least one network and operational failure of the one or more nodes and the one or more runtimes deployed in the distributed dataflow-based framework based on implementation of the one or more bridge wires; and
attaining, by a resiliency attaining subsystem, a predefined level of resiliency of the distributed data flow-based framework over the one or more bridge wires in at least one condition based on the loss of connectivity of the at least one network and operational failure of the one or more nodes detected.
